(19) United States
(12) Patent Application Publication
(10) Pub. No.: US 2018/0079272 A1
(43) Pub. Date: Mar. 22, 2018

(54) MOTION MINIMIZATION SYSTEMS AND METHODS

(71) Applicant: Apple Inc., Cupertino, CA (US)

(72) Inventor: Randol W. Aikin, Sunnyvale, CA (US)

(73) Assignee: Apple Inc., Cupertino, CA (US)

(21) Appl. No.: 15/709,384

(22) Filed: Sep. 19, 2017

Related U.S. Application Data
(60) Provisional application No. 62/396,995, filed on Sep. 20, 2016.

(51) Int. Cl. B60G 17/0195; B60W 30/02; G05D 1/00; B60W 10/22; B60W 10/20; B60G 17/0165

(52) U.S. Cl. CPC B60G 17/0195; B60W 30/02; G05D 1/0088; B60W 10/22; B60W 10/20; B60G 2400/821; G05D 2201/0212; B60W 2550/143; B60W 2550/406; B60W 2710/223; B60W 2550/402; B60G 17/0165

(57) ABSTRACT

A method includes receiving, at a control system of a vehicle, a road profile for a road at a particular location, the road profile indicating a road condition of the road at the particular location. The method also includes determining that the vehicle is approaching the road at the particular location. The method further includes adjusting an active suspension system of the vehicle in response to a determination that the vehicle is approaching the road at the particular location.

This application claims benefit of priority to U.S. Provisional Application No. 62/396,995, filed Sep. 20, 2016, titled “Motion Minimization Systems and methods,” which is hereby incorporated by reference in its entirety.

### BACKGROUND

### Technical Field

This disclosure relates generally to suspension of a vehicle and, in particular, to a proactive motion minimization system for a vehicle.

### Description of the Related Art

Comfort of a passenger in a vehicle is generally managed with passive hardware elements, such as seats, dampers, bushing, springs, jounce bumpers, etc. The passive hardware elements are configured to attenuate lateral, longitudinal or vertical accelerations resulting from the vehicle driving over a road. The passive hardware elements act as a filter of the accelerations to minimize cabin movement and, accordingly, passenger movement. Passive management of the accelerations, such as air suspension, generally results in no attenuation of acceleration at lower frequencies (e.g., lower than a primary ride frequency) or limited attenuation at higher frequencies (e.g., above the primary ride frequency). Air suspension systems are also slow to react to rapid changes in road conditions.

Active suspension systems exert force on suspension of the vehicle to better attenuate the accelerations resulting from driving over the road than with a passive suspension system. The active suspension system can include a hydraulically actuated suspension that uses a hydraulic pump to apply pressure to the suspension. The active suspension system is configured to trigger the hydraulic actuated suspension based at least in part on a skyhook control algorithm. The active suspension system also includes sensors configured to measure damper velocity, wheel displacement, body acceleration, etc. Because the sensors are configured to sense current road conditions, the active suspension system is reactive to the current road conditions.

### SUMMARY

Motion minimization systems and methods are disclosed herein. A motion minimization system includes a one or more sensors coupled to one or more wheels of a vehicle and at least one road sensor configured to receive a road input based at least in part on a road condition at a particular location. A controller is configured to generate a road profile based at least in part on wheel movement data from the one or more sensors and to adjust an active suspension system based at least in part on the road profile. The road profile can be stored to a memory and retrieved at a later time when the vehicle approaches the particular location.

In one embodiment, a method to minimize motion of a vehicle is disclosed. The method includes receiving, at a control system of a vehicle, a road profile for a road at a particular location, the road profile indicating a road condition of the road at the particular location. The method also includes determining that the vehicle is approaching the road at the particular location. The method further includes adjusting an active suspension system of the vehicle in response to a determination that the vehicle is approaching the road at the particular location.

In another embodiment, a system is disclosed. The system includes an active suspension system coupled to a plurality of wheels of a vehicle. The system also includes one or more sensors coupled to the plurality of wheels, the one or more sensors configured to generate sensor data based on road inputs applied to the plurality of wheels. The system further includes a location sensor configured to generate location data indicating a current location of the vehicle. The system also includes a controller configured to receive a road profile indicating a road condition of a road at a particular location. The controller is also configured to update the road profile based on the sensor data. The controller is further configured to store the road profile to a memory of the vehicle.

In yet another embodiment, a computer-readable storage medium is disclosed. The computer-readable storage medium stores instructions that, when executed by one or more processors, cause the one or more processors to perform operations. The operations include receiving a road profile indicating a road condition at a particular location. The operations also include receiving, from one or more sensors of a vehicle, a road input based on a current road condition at the particular location. The operations further include updating the road profile based at least in part on the road input.

### BRIEF DESCRIPTION OF THE DRAWINGS

FIG. 1 illustrates a vehicle which includes a motion minimization system, according to some embodiments.

FIG. 2 illustrates a motion minimization system that includes a vehicle and one or more sensors configured to sense upcoming road hazards, according to some embodiments.

FIG. 3 illustrates a motion minimization system that includes a vehicle and a road profile configured to inform the vehicle of upcoming road hazards, according to some embodiments.

FIG. 4 illustrates a motion minimization system that includes a vehicle and a profile library, according to some embodiments.

FIGS. 5A-B illustrate a vehicle which includes a motion minimization system configured to transmit road profile data to an infrastructure system.

FIG. 6 illustrates multiple vehicles including motion minimization systems configured to communicate with other vehicles regarding road profile data.

FIG. 7 illustrates a flowchart diagram of a method to minimize motion of a vehicle, according to some embodiments.

FIG. 8 illustrates a flowchart diagram of a method to store and send a suspension adjustment profile to minimize motion of a vehicle, according to some embodiments.

FIG. 9 illustrates an example computer system configured to implement one or more portions of a motion minimization system, according to some embodiments.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based at least in part on.” As used herein, this term is used to describe one or more factors that affect a determination. This term does not foreclose additional factors that may affect a determination. That is, a determination may be solely based at least in part on those factors or based, at least in part, on those factors. Consider the phrase “determine A based at least in part on B.” While in this case, B is a factor that affects the determination of A, such a phrase does not foreclose the determination of A from also being based at least in part on C. In other instances, A may be determined based solely on B.

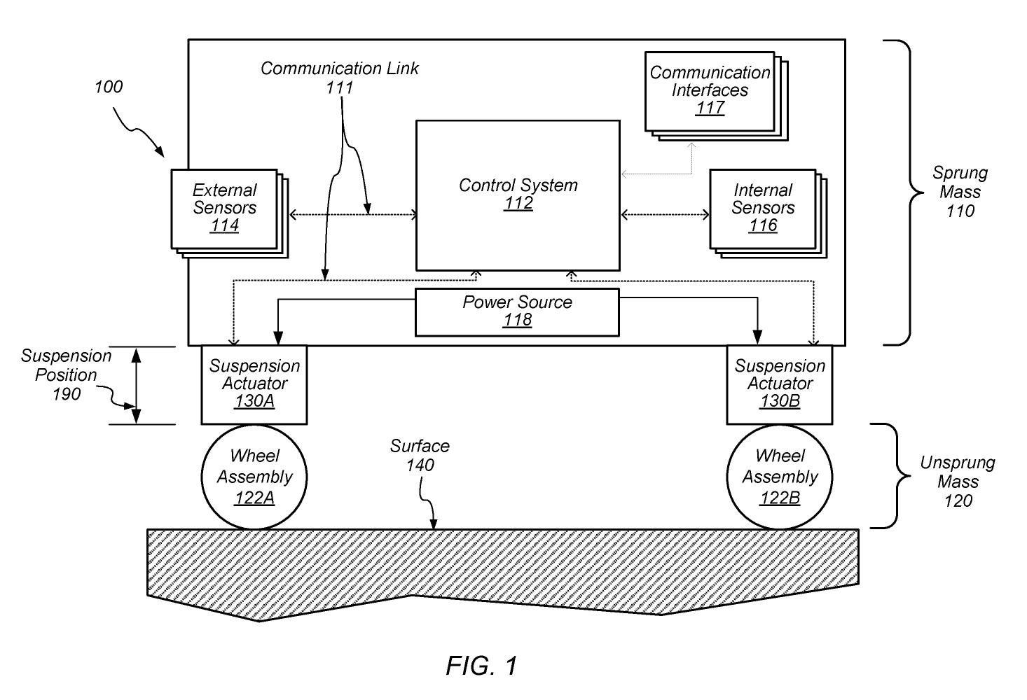

FIG. 1 illustrates a schematic block diagram of a vehicle 100, which may include a control system 112, according to some embodiments. The vehicle 100 may include one or more external sensors 114, one or more internal sensors 116, one or more communication interfaces 117, a power source 118, a set of suspension actuators 130A-B coupled to separate wheel assemblies 112A-B, a sprung mass 110 which rests on the suspension actuators 130A-B, and an unsprung mass 120 which includes the set of wheel assemblies 112A-B. The vehicle 100 may come in contact with a surface 140 with the set of wheel assemblies 112A-B. The surface 140 may include a road, a dirt path, pavement, stone, or any other type of surface on which the vehicle 100 drives.

The vehicle 100 will be understood to encompass one or more vehicles of one or more various configurations which can accommodate one or more occupants, including, but not limited to, one or more automobiles, trucks, vans, etc. The vehicle 100 may include one or more interior cabins (e.g., a vehicle interior) configured to accommodate one or more human occupants (e.g., passengers, drivers, etc.), which are collectively referred to herein as vehicle occupants. The vehicle interior may include the one or more user interfaces, including one or more driving control interfaces (e.g., a steering device, a throttle control device, a brake control device), display interfaces, multimedia interfaces, climate control interfaces, or any combination thereof, or the like.

As discussed herein, the control system 112 may be configured to control one or more control elements, based at least in part on data received from the internal sensors 116, the external sensors 114, or both. The control system 112 may be communicatively coupled to the internal sensors 116 and the external sensors 114 via communication links 111. In some embodiments, the control elements may include suspension actuators 130A-B of an active suspension system that is configured to reduce movement of the sprung mass 110 (e.g., a body of the vehicle or a vehicle interior) during operation of the vehicle 100. Accordingly, the control system 112 may control the suspension actuators 130A-B based at least in part on the data received from the external sensors 114, the internal sensors 116, or both.

The external sensors 114 may be configured to monitor one or more aspects of an exterior environment, such as a location sensor (e.g., a global positioning satellite system (GPS)), an optical sensor (e.g., a camera device), a radar device, a light radar (lidar) device, a light beam scanning device, a microphone device, or any combination thereof, etc.

The internal sensors 116 may be configured to monitor one or more aspects of the vehicle 100 in real-time or near real-time, including one or more wheel sensors that monitor movement of one or more wheel assemblies 122A-B. The one or more wheel sensors may include wheel spin sensors that monitor wheel spin rates of the one or more wheel assemblies 122A-B, accelerometers that monitor acceleration of each wheel assembly 122A-B of the vehicle 100, position monitors that monitor a position of one or more components of the suspension actuators 130A-B, sensors which monitor navigation of the vehicle 100 along a particular driving route, sensors which monitor one or more of acceleration, velocity, position, etc., of the vehicle 100 along a road surface, or any combination thereof, etc.

The vehicle 100 may include an unsprung mass 120 which includes the set of wheel assemblies 122A-B, the set of suspension actuators 130A-B with each suspension actuator coupled to separate wheel assemblies and a sprung mass which rests on the suspension actuators. In some embodiments, each wheel assembly of the set of wheel assemblies 122A-B may include an accelerometer configured to measure wheel movement of each of the wheel assemblies 122A-B. The accelerometer may be coupled to a wheel of the wheel assembly, an axle of the wheel assembly, a tire tread of a tire coupled to the wheel, or any combination thereof. In some embodiments, each wheel assembly of the set of wheel assemblies 122A-B may include a displacement sensor configured to measure displacement of the wheel assembly during motion of the vehicle 100. In other embodiments, each wheel assembly of the set of wheel assemblies 122A-B may include an inertial measurement unit configured to measure force applied to the wheel assembly during motion of the vehicle 100. The wheel assemblies 122A-B may have a resonance of approximately 10-12 Hz that may be based on stiffness of tires coupled to the wheel assemblies 122A-B. In some embodiments, the tires may be configured to filter small oscillations at higher frequencies, such as a rock on the surface 140. Larger oscillations, such as potholes, train tracks or cleats, may be compensated by the suspension actuators 130A-B. Each of the suspension actuators 130A-B may include a hydraulically-driven piston and a variable pressure air spring. In some embodiments, the hydraulically-driven piston may include a pump that diverts fluid to create actuation in the suspension actuators 130A-B by pushing or pulling the piston. The hydraulically-driven piston may have a response time with a bandwidth of approximately 10-30 Hz. The power source 118 may provide power to each of the suspension actuators 130A-B to drive or activate the hydraulically-driven piston or the variable pressure air spring. A particular suspension actuator 130A may be configured to actuate the piston to implement high-frequency control of a suspension position 190 and to actuate the variable pressure air spring to implement low-frequency control of the suspension position 190. The suspension position 190 may be adjusted for each of the suspension actuators 130A-B. As referred to herein, low-frequency refers to a frequency which is less than the primary ride frequency, and high-frequency refers to a frequency which is at least equal to (i.e., greater than or equal to) the primary ride frequency, where the primary ride frequency refers to a natural frequency of the sprung mass. In some embodiments, the primary ride frequency may be a resonant mode of the active suspension system and may be approximately 1 Hz.

A suspension actuator 130B may include a combination of a hydraulically-driven piston and a variable pressure air spring, in some embodiments. The suspension actuator 130B enables displacement of the suspension position with significantly reduced power consumption as compared to alternative designs, based at least in part upon the control of the variable pressure air spring to adjust a neutral suspension position of the suspension actuator, where a neutral suspension position, as referred to herein, refers to a suspension position 190 at which negligible power consumption by the suspension actuator 130B is required for the suspension actuator 130B to maintain the suspension position 190. In some embodiments, the suspension actuator 130B may adjust the neutral suspension position to prevent the vehicle 100 from bottoming out when passing over a road hazard in the surface 140 that is detected by the external sensors 114. For example, the suspension actuator 130B may raise the neutral suspension position in anticipation of the road hazard detected by the external sensors 114 such that when a vertical position of the vehicle 100 is lowered, the unspring mass 110 does not come in contact with the surface 140.

The control system 112 may include a road profile module configured to receive a road profile corresponding to, associated with or otherwise based on a road condition at a particular location. The road profile may be used by the control system 112 to adjust the control elements. In a particular embodiment, the road profile may indicate to the control system 112 that the vehicle is approaching a particular road condition in the surface 140 (e.g., a pothole) that was previously determined and stored to the road profile. Based on information from the road profile, the control system 112 may adjust the control elements proactively in anticipation of the pothole. For example, the control system 112 may cause the control elements to adjust only a driver-side set of suspension actuators 130A-B in response to the pothole being on the driver-side of the surface 140. In some embodiments, the road profile may serve as a map of commonly traveled routes and corresponding road conditions. In other embodiments, the road profile may indicate a road type at the particular location. The control system 112 may adjust the control elements based on the road type. For example, the road profile may indicate that the road type of the surface 140 at the particular location as being a part of a highway. Based on the road type being a highway, the control system 112 may cause the control elements to lower a ride height of the vehicle 100 to improve aerodynamics. In some embodiments, the road profile may indicate that there are frequent bumps or occlusions in the surface 140. The control system 112 may increase the ride height of the vehicle 100 to prevent the unsprung mass 120 from colliding with the sprung mass 110 (e.g., a “bottom-out”).

The road profile module may also be configured to generate the road profile. The road profile may be generated based at least in part on data received from the external sensors 114, the internal sensors 116, or both. In some embodiments, the road profile module may be configured to generate the road profile in real-time or near real-time as the vehicle 100 is traveling down the road. In other embodiments, the road profile module may be configured to generate the road profile at a later time when the vehicle 100 is no longer in motion (e.g., offline calculation). For example, the road profile module may be configured to delay generation of the road profile to dedicate more computational resources to determining a suspension adjustment while the vehicle is in motion. In some embodiments, the road profile may be obtained or received from an external source, such as a remote server or database.

The control system 112 may determine or generate a force profile based at least in part on the road profile. The force profile may correspond to particular force adjustments to the suspension actuators 130A-B required for a smooth ride over a particular road segment identified in the road profile. The force profile may be adjusted over time to minimize the frequency response from the surface 140, such as from bumps or other road hazards. In some embodiments, the force profile may also be adjusted based on the current speed of the vehicle 100. For example, the force profile may indicate that less force is required on the suspension actuators 130A-B when the vehicle 100 is traveling faster than previous trips over the road segment. In some embodiments, the control system 112 the force profile may adjust force applied to the wheel assemblies 122A-B of the vehicle 100. For example, the force profile may increase the force applied to the wheel assemblies 122A-B to prevent rapid or uncontrolled movement when the vehicle 100 passes over a particular road hazard. In other embodiments, the force profile may automatically move the wheel assemblies 122A-B with a particular force to guide the vehicle 100 over a particular road configuration, such as a turn or a curve in the road. For example, the force profile may apply a force and guide the wheel assemblies 122A-B to turn the vehicle 100 around a curve without interaction from the driver, such as in an autonomous or self-driving vehicle.

Over time, the road profile can be improved to determine optimal suspension and vehicle commands. In some embodiments, the road profile may be improved utilizing a receding time horizon control strategy. Multiple traversals over the surface 140 at the particular location may be used to iteratively optimize the road profile. For example, each traversal over the surface 140 may improve a root-mean-square (RMS) acceleration of a particular wheel assembly, peak acceleration of a particular wheel assembly, RMS jerk of a particular wheel assembly, or any combination thereof. As such, the road profile is progressively improved each time the vehicle 100 traverses over the surface 140. In situations where optimization of the road profile may be too computationally intensive to be performed in real-time or near real-time during travel, computation of optimization may be deferred to a later time, such as later in the day or overnight. As discussed above, the road input may be measured based on high-bandwidth accelerations at each of the set of wheel assemblies. The road input may be correlated with location data from the location sensor, the optical sensor, or both. For example, the location data may be based on a GPS signal identifying a location of the vehicle 100. In another example, the location data may be based on the optical sensor indicating that the vehicle 100 is in a particular lane of the road based on relative positions of lane markers and corresponding colors of the lane markers. Trajectory of the vehicle 100 may also be recorded as part of the road input. The road profile may be optimized to minimize vertical acceleration of the vehicle 100, longitudinal acceleration, lateral acceleration, body pitch, body roll, or any combination thereof. In a particular embodiment, the road profile module 122 may make iterative adjustments to the road profile each time a particular location is passed by the vehicle 100. Each iteration may be analyzed by the control system 112 to determine if the iteration improved or diminished performance of the control elements based on movement of the unsprung mass 120. Additionally, the road profile may be adjusted by the vehicle 100 based on factors that are time-specific to the vehicle 100. For example, the vehicle 100 may adjust the road profile based on current speed or current vehicle loading conditions of the vehicle 402. The current vehicle loading conditions may vary based at least in part on current passenger occupancy or cargo weight. The road profile may also indicate a tire tread depth corresponding to a particular time in which the road profile was generated. The vehicle 100 may further adjust the road profile based on a current tire tread depth.

In some embodiments, the road profile may be used to generate or determine a suspension adjustment profile that may be used by the control system 112 to adjust the suspension actuators 130A-B. The suspension adjustment profile may also be referred to as a force profile. For example, the suspension adjustment profile may cause the control system 112 to increase actuation of the suspension actuator 130A and decrease actuation of the suspension actuator 130B based on a road hazard (e.g., a pothole) or road configuration (e.g., a turn in the road). In some embodiments, the suspension adjustment profile may correlate or associate a particular force adjustment with particular high-bandwidth accelerations of the unsprung mass 120 and a particular location indicated by the road profile. The force adjustment may indicate that a force is to be applied to a particular control element, such as a suspension actuator or a wheel assembly, to minimize the high-bandwidth accelerations applied to the vehicle 100. For example, the vehicle 100 may have a wheel assembly that is controlled based on the force profile such that movement of the wheel assembly is not controlled by the driver. In some embodiments, the vehicle 100 may be location-aware by the external sensors 114, such as a global positioning system (GPS) providing location data to the vehicle 100. Based on location and the force profile, the control system 112 may cause one or more forces to be applied to the suspension actuators 130A-B or the wheel assemblies 122A-B.

Because the optimal force profile necessary to achieve some cost function may not be possible to calculate in real-time, either because the disturbance to the vehicle from the road profile is not perfectly known or because it is computationally infeasible to fully optimize over all degrees of freedom, the optimal force profile may be refined over time using numerical optimization methods. The suspension adjustment profile or the force profile may be refined over time using any suitable algorithms, such as model predictive control, gradient-based optimization, random search, multi-linear regression, or any other appropriate machine learning algorithm. For example, a gradient-based optimization method may include adjusting the active suspension force profile of each actuator, either by increasing or decreasing controller gains after traversing the same road section on multiple passes. A gradient descent technique can be used to numerically optimize controller gains after traversing the same road section over time. In some embodiments the road profile may be analyzed to determine the road inputs used in generating the road profile to determine displacements of the unsprung mass 120 at particular times to refine the road profile. In one particular embodiment, model predictive control or receding time horizon control may be used by the control system 112 to refine or optimize the suspension adjustment profile over one or more iterations of suspension adjustment. For example, when the vehicle 100 drives over a particular road segment, the control system 112 may use the suspension adjustment profile to minimize movement from high-bandwidth accelerations (e.g., vertical acceleration, body pitch and roll, heave, longitudinal acceleration and lateral acceleration) of the sprung mass 110. For example, the suspension adjustment profile may indicate for an upcoming curve in the road to adjust stiffness of the body pitch and roll to minimize motion of the sprung mass 110 while taking the curve. In some embodiments, the control system 112 may adjust different components of the active suspension system independently from other components. For example, the body pitch and roll may be independently adjusted from the heave during a particular motion of the vehicle, such as the vehicle driving over the curve.

The internal sensors 116 may measure the movement and the high-bandwidth accelerations of the sprung mass 110 to determine whether the suspension adjustment profile was adequate in reducing movement of the sprung mass 110. Based on measurements by the internal sensors 116, the control system 112 may make adjustments to the suspension adjustment profile in order to further minimize motion of the sprung mass 110. In subsequent iterations (e.g., driving over the particular road segment at a later time), the control system 112 may use an updated or adjusted version of the suspension adjustment profile. The internal sensors 116 again may measure the movement and the high-bandwidth accelerations of the sprung mass 110 to determine whether the updated suspension adjustment profile was adequate in reducing movement of the sprung mass 110. The control system 112 may make additional adjustments to the suspension adjustment profile for additional iterations in the future. Over multiple iterations, the adjustments to the suspension adjustment profile may be optimized such that subsequent adjustments to the suspension adjustment profile are relatively minor compared to previous adjustments thus receding the prediction horizon associated with the model predictive control. Additionally, the suspension adjustment profile may be adjusted by the vehicle 100 based on factors that are time-specific to the vehicle 100. For example, the vehicle 100 may adjust the suspension adjustment profile based on current speed or current vehicle loading conditions of the vehicle 102. Each iteration may take into account the current speed or the current vehicle loading conditions when determining optimization or adjustments for subsequent iterations.

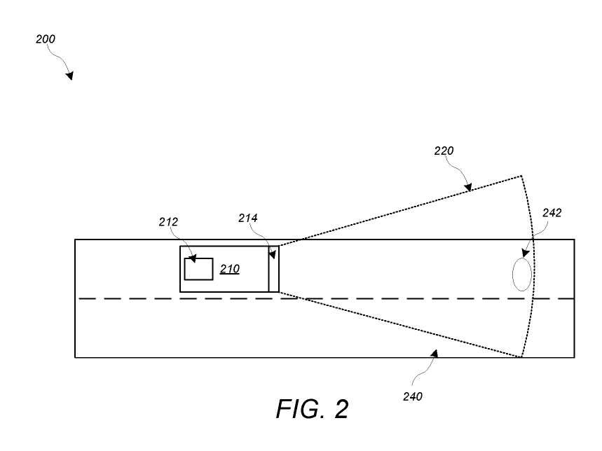

FIG. 2 illustrates a motion minimization system 200 that includes a vehicle 210 and one or more sensors 214 configured to sense upcoming road hazards, according to some embodiments. The vehicle 210 may include a control system 212 configured to adjust an active suspension system of the vehicle 210. The control system 212 may determine on whether and how to adjust the active suspension system based on one or more sensors 214 configured to look ahead of the vehicle 210 for potential road hazards. The one or more sensors 214 may include an accelerometer, a location sensor (e.g., a global positioning satellite system (GPS)), an optical sensor (e.g., a camera device), a radar device, a light radar (lidar) device, a light beam scanning device, a microphone device, or any combination thereof, etc. The one or more sensors 214 may be configured to detect objects within a field of view 220 of a road 240. In some embodiments, the one or more sensors 214 may be configured to detect a road hazard 242, such as a pothole, on the road 240 within the field of view 220.

The one or more sensors 214 may indicate to the control system 212 that the vehicle 210 is approaching road hazard 242. As the vehicle 210 approaches the road hazard 242, the control system 212 may determine or generate a road profile of the road 240 based on data collected by the one or more sensors 214. For example, the road profile may indicate that the road hazard 242 is present on the road 240 at a particular location. The road profile may indicate the particular location of the road hazard 242. In some embodiments, the road profile may indicate a particular lane of the road 240 in which the road hazard 242 is located. The control system 212 may adjust the active suspension system 210 based on a determination that the vehicle will pass over or come in contact with the road hazard 242. In some embodiments, the control system 212 may adjust a ride height of the vehicle 210 to prevent wheels of the vehicle 210 from coming in contact with other parts of the vehicle 210.

In some embodiments, the control system 212 may save the road profile to a memory of the vehicle 210. The control system 212 may be configured to recall the road profile at a subsequent time when the vehicle 210 is on the road 240 and approaching the road hazard 242.

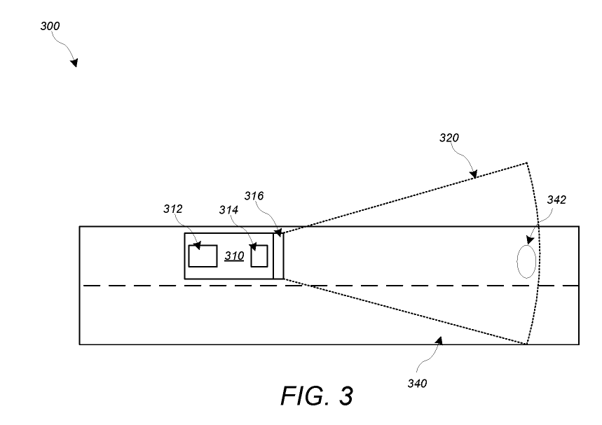

FIG. 3 illustrates a motion minimization system 300 that includes a vehicle 310 and a road profile 314 configured to inform the vehicle 310 of upcoming road hazards, according to some embodiments. The vehicle 310 may include a control system 312 configured to adjust an active suspension system of the vehicle 310. The control system 312 may determine on whether and how to adjust the active suspension system based on a road profile 314 stored on the vehicle 310. The road profile 314 may indicate to the control system 312 that the vehicle 310 is approaching a road hazard 342. The control system 312 may determine or confirm the road hazard 342 based on information received by one or more sensors 316. The one or more sensors 316 may include an accelerometer coupled to the wheel assembly, an accelerometer embedded in a tire tread, a location sensor (e.g., a global positioning satellite system (GPS)), an optical sensor (e.g., a camera device), a radar device, a light radar (lidar) device, a light beam scanning device, a microphone device, or any combination thereof, etc. The one or more sensors 316 may be configured to detect objects within a field of view 320 of a road 340. In some embodiments, the one or more sensors 316 may be configured to detect a road hazard 342, such as a pothole, on the road 340 within the field of view 320.

In some embodiments, the control system 312 may prepare for the road hazard 342 by reading data from the road profile 314 that may indicate previous adjustments to the active suspension system of the vehicle 310. For example, the road profile 314 may indicate that in a previous drive over the road hazard 342 that the vehicle 310 was raised a particular height to minimize vertical motion of the vehicle 310. The road profile 314 may indicate a particular location corresponding to the road hazard 342 such that the control system 312 may anticipate the road hazard 342 prior to the road hazard 342 entering the field of view 320 of the one or more sensors 316. In another example, the road profile 314 may indicate that the road hazard 342 is limited to a particular portion of the road 340. The control system 312 may be configured to adjust only portions of the active suspension system based on the particular portion of the road 340 relative to the vehicle 310. For example, the road hazard 342 may be a small pothole on a passenger side of the vehicle 310. Based on the road profile 314 indicating the size and location of the road hazard 342, the control system 312 may adjust only portions of the active suspension system corresponding to the passenger side of the vehicle 310.

The control system 312 may be configured to avoid the road hazard 342 by directing the vehicle 310 to an alternative path. For example, the road 340 may include multiple lanes in the same direction such that the vehicle 310 may safely avoid the road hazard 342 by changing lanes. In some embodiments, the control system 312 may indicate to a driver of the vehicle 310 that another lane would be optimal to avoid the road hazard 342. For example, the control system 312 may cause the vehicle 310 to recommend an alternative route or path based on an indication of the road hazard 342. In other embodiments, the control system 312 may cause an autonomous vehicle to automatically change paths or change lanes based on a determination that the road hazard 342 can be avoided. For example, the control system 312 may cause the autonomous vehicle to change lanes in advance of the road hazard 342. In another example, the control system 312 may cause the autonomous vehicle to shift a small distance in a lateral direction, such as inches to the left or right, to avoid the road hazard 342. In yet another example, the control system 312 may change an entire path of the autonomous vehicle based on a determination of severity of the road hazard 342.

In some embodiments, the control system 312 may be used to determine a complete path from an origin location to a destination location based on the road profile 314. For example, the road profile 314 may indicate a particular path that has minimal road hazards, such as the road hazard 342. The control system 312 may indicate to the vehicle 310 that the particular path the optimal route. In some embodiments, the vehicle 310 may display the particular path via an on-board display such as a heads-up display or a console display configured to display information to a passenger of the vehicle 310. In another embodiment, the vehicle 310 may be an autonomous vehicle and automatically travel along the particular path without any interaction from the passenger.

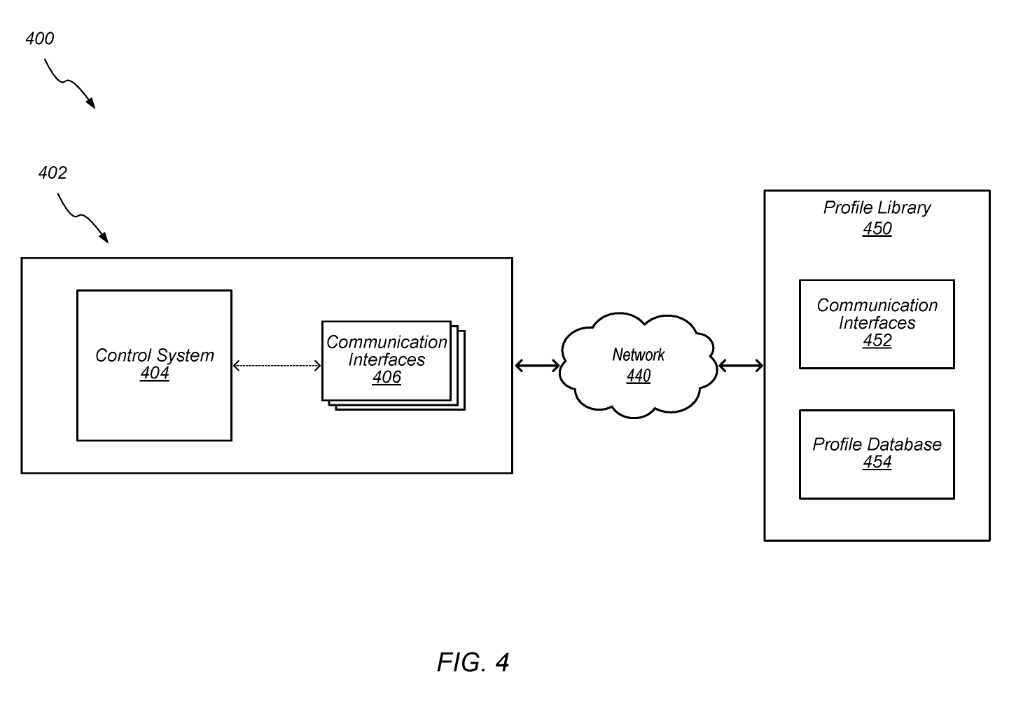

FIG. 4 illustrates a block diagram of a motion minimization system 400 including a vehicle 402 and a profile library 450. The vehicle 402 may correspond to the vehicle 100 as described with reference to FIG. 1.

The vehicle 402 may have one or more communication interfaces 406 configured to communicate with the profile library 450 via a network 440. The network 440 may, in various embodiments, include one or more networks including but not limited to Local Area Networks (LANs) (e.g., an Ethernet or corporate network), Wide Area Networks (WANs) (e.g., the Internet), wireless data networks, some other electronic data network, or some combination thereof. The vehicle 402 may generate a road profile based on road conditions, wheel movement data, or both, as described herein. The vehicle 402 may send, via the one or more communication interfaces 406 coupled to the network 440, the road profile to the profile library 450. The profile library 450 may be a remote server with respect to the vehicle 402.

The profile library 450 may include one or more communication interfaces 452 configured to communicate with the vehicle 402 via the network 440. In one embodiment, the communication interfaces 452 of the profile library 450 may receive the road profile from the vehicle 402 via the network 440. The communication interfaces 452 may be of any suitable type compatible with the types of networks that make up the network 440. For example, the network 440 may in various embodiments include one or more networks including but not limited to Local Area Networks (LANs) (e.g., an Ethernet or corporate network), Wide Area Networks (WANs) (e.g., the Internet), wireless data networks (e.g., CDMA, TDMA, GSM, 3G, LTE, WiMax, etc.) some other electronic data network, or some combination thereof.

The profile library 450 may aggregate multiple road profiles received from multiple vehicles and store the multiple road profiles in a profile database 454. The profile library 450 may include hardware components such as system memory, general purpose processors and various interfaces to provide the profile database 454. In some embodiments, a computing device implementing the profile database 454 includes one or more processors coupled to a system memory via an input/output (I/O) interface. In some cases, it is contemplated that embodiments may be implemented using a single instance of a computing device, while in other embodiments multiple such systems, or multiple nodes making up computing system, may be configured to host different portions or instances of the profile database 454.

In some embodiments, the profile library 450 may be configured to receive sensor data and suspension adjustment data from the vehicle 402. The sensor data may include data captured by one or more sensors of the vehicle 402 that may indicate a particular location of a road hazard of a road. The suspension adjustment data may include data corresponding to adjustments of an active suspension system that were performed in real-time or near real-time as the vehicle 402 drove over the road hazard. Based on the sensor data and the suspension adjustment data, the profile library 450 may calculate the road profile off-site relative to the vehicle 402. In some embodiments, the profile library 450 may be computationally stronger than the vehicle 402. For example, the profile library 450 may have components or computing devices dedicated to generating the road profile, whereas the vehicle 402 may require additional computational power to detect future road hazards while driving down a road.

The profile library 450 may be configured to further refine the road profile at the profile database 454. Any vehicles that obtain the road profile from the profile library 450 may have additional data captured by other vehicles. For example, the vehicle 402 may acquire or download the road profile from the profile library 450 that includes aggregated road profiles from a plurality of other vehicles. In a particular embodiment, the road profile sent to the vehicle 402 may include additional information about a particular road segment that the vehicle 402 may have not been located at previously. However, a different vehicle may have traversed or driven over the road segment and generated a road profile corresponding to the road segment. The other vehicle may be configured to send the road profile corresponding to the road segment to the profile library 450 prior to the vehicle 402 arriving at the road segment. Thus, the vehicle 402 may preemptively anticipate road hazards without directly acquiring information regarding the particular road prior to driving over the particular road segment.

The road profile from the profile library 450 could possibly not be tuned or optimized for the vehicle 402 because the road profile may be based on a plurality of other vehicles that have different load specifications or configurations. For example, another vehicle may be a sports utility vehicle while yet another vehicle may be a coupe. To compensate for various different factors in capturing data for the road profile, the road profile may be adjusted by the vehicle 402 based on factors that are specific to the vehicle 402. For example, the vehicle 402 may adjust the road profile based on current speed or current vehicle loading conditions of the vehicle 402. The current vehicle loading conditions may vary based at least in part on current passenger occupancy or cargo weight. Other factors may include current weather conditions, such as rain or snow, that may require additional adjustments.

The profile library 450 may be configured to receive and refine suspension adjustment profiles or force profiles in addition to or instead of the road profile. The vehicle 402 may be configured to send a suspension adjustment profile to the profile library 450 via the network 440 using the one or more communication interfaces 406. The suspension adjustment profile may include information identifying a type of vehicle, a particular location and one or more particular adjustments, as described herein. The profile library 450 may store the suspension adjustment profile to the profile database 454. The profile library 450 may aggregate multiple suspension adjustment profiles from multiple vehicles, including the vehicle 402, in the profile database 454.

The vehicle 402 may request a suspension adjustment profile corresponding to a particular road segment from the profile library 450, such as when the vehicle 402 has not traveled over the particular road segment. The profile library 450 may send the suspension adjustment profile from the profile database 454 to the vehicle 402 via the network 440 using the one or more communication interfaces 452. In some embodiments, the profile library 450 may restrict the vehicle 402 from receiving the suspension adjustment profile from a particular vehicle make or model when the vehicle 402 has a different vehicle make or model. In other embodiments, the profile library 450 may send the suspension adjustment profile, and the vehicle 402 may be configured to modify the suspension adjustment profile based on known differences between the make or model of the vehicle 402 and a different make or model associated with the received suspension adjustment profile.

In some embodiments, the profile library 450 may be operated at a remote server, such as in the cloud. In other embodiments, the profile library 450 may be operated as part of a road infrastructure, such as a road sign or checkpoint, along a road. For example, a road sign along a highway may be configured to house and operate the profile library 450 such that the road sign is configured to send or receive road profiles or suspension adjustment profiles from a vehicle 402 driving past the road sign. The profile library 450 on the road sign would be accessible via a local connection such as a local area network (LAN), Bluetooth, near field communication (NFC), or any other suitable short-range communication protocol. The vehicle 402 may also be configured to communicate with the profile library 450 via a vehicle-to-infrastructure (V2I) communication protocol.

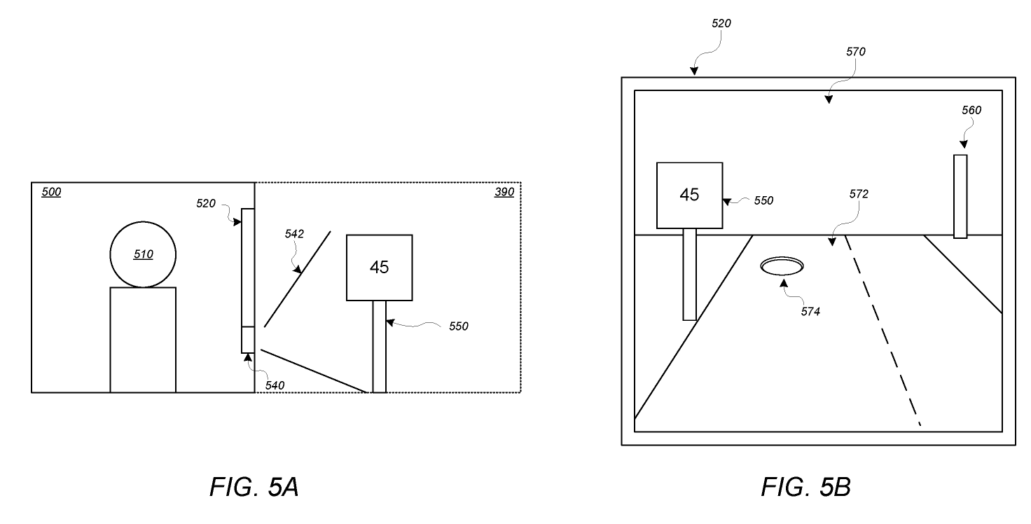

FIGS. 5A-B illustrate a vehicle 500 configured to transmit and receive information about a road segment, according to some embodiments. The vehicle 500 illustrated in FIGS. 5A-B can be included in any of the embodiments of vehicles included herein.

The vehicle 500 may have an occupant 510 (e.g., a driver or a passenger of the vehicle 500). The vehicle 500 may include a transparent surface 520 (e.g., a windshield or a window) and one or more external sensors 540. The one or more external sensors 540 may be configured to monitor 542 one or more portions of environment 570 in which the vehicle 500 is located. The environment 570 may include a road segment 572.

In some embodiments, the one or more sensors 540 may be configured to receive data from an infrastructure landmark, such as a road sign 550. For example, the road sign 550 may include computer components, such as a processor and a memory, to manage and operate a profile library. The profile library at the road sign 550 may correspond to the profile library 450 described with reference to FIG. 4. The data may include a road profile or a suspension adjustment profile associated with or corresponding to the road segment 572. For example, the road profile may indicate that a road hazard 574 (e.g., a pothole or a speed bump) may be located or present on the road segment 572. As another example, the suspension adjustment profile may indicate adjustments to an active suspension system such that the vehicle 500 may minimize motion of the occupant 510 when driving over the road segment 572 and the road hazard 574.

After the vehicle 500 drives over the road segment 572 and the road hazard 574, the vehicle 500 may update the road profile or the suspension adjustment profile or generate a new road profile or a new suspension adjustment profile based on current road conditions or other factors (e.g., vehicle speed, vehicle angular trajectory, weather, etc.). The vehicle 500 may be configured to transmit the road profile or the suspension adjustment profile to another infrastructure landmark, such as road marker 560. The road marker 560 may also be configured to store other road profiles for subsequent road segments. The road marker 560 may be configured to send the other road profiles for the subsequent road segments to the vehicle 500 similar to the road sign 540.

In some embodiments, the road sign 550 and the road marker 560 may be configured to communicate such that the road profile for the road segment 572 updated on the road sign 550 based on data received by the road marker 560 from the vehicle 500. In other embodiments, the vehicle 500 may store the road profile corresponding to the road segment 572 in a memory of the vehicle 500. At a later time, the vehicle 500 may send the road profile to the road sign 550 when the vehicle 500 drives by the road sign 550 such that the road sign 550 may update and send the road profile to other vehicles.

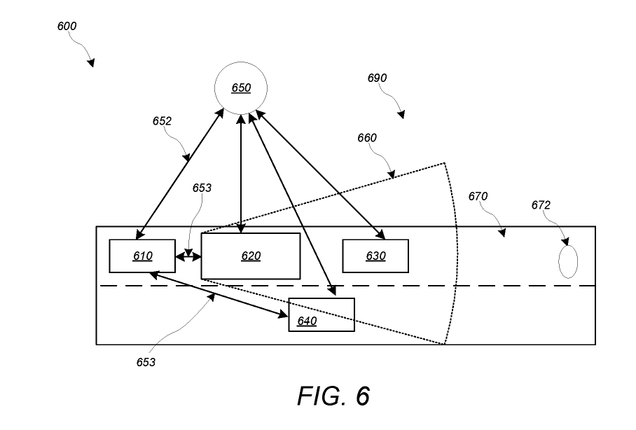

FIG. 6 illustrate a motion minimization system 600 configured to adjust an active suspension system of vehicles based on a road profile, according to some embodiments. The vehicles illustrated in FIG. 6 can be included in any of the embodiments of vehicles and transparent surfaces included herein.

In some embodiments, the motion minimization system 600 may include a vehicle 610 navigating through an environment 690 which includes a road segment 670. The motion minimization system 600 may be configured to generate a road profile based on the road segment. The vehicle 610 may have an obstructed view 660 of the road segment 670 because other vehicles 620, 630 and 640 may be physically blocking the vehicle 610 such that one or more external sensors of the vehicle 610 are unable to detect complete information about the road segment 670. For example, the road segment 670 may include a road hazard 672 (e.g., a pothole, a speed bump, a quick change in vertical height, etc.).

In some embodiments, the motion minimization system 600 receives information associated with the vehicle 630, including sensor data, a road profile or a suspension adjustment profile, based on communication with one or more of a remote system 650 via a communication link 652, vehicle-to-vehicle (V2V) communication with one or more of the vehicles 620, 640 via links 653, etc. The vehicles 620, 640 may be in communication with the vehicle 630 via the communication link 652 or a V2V communication. The vehicle 630 may detect or sense the road hazard 672 before the vehicles 610, 620, 640 can. The vehicle 630 may send the road profile to the vehicles 61, 620, 640. The vehicles 610, 620, 640 may preemptively adjust corresponding active suspension systems based on the road profile generated by the vehicle 630 to minimize motion of the vehicles 610, 620, 640 when driving over the road hazard 672.

In some embodiments, one or more of the vehicles 610, 620, 640 may update the road profile after passing over the road hazard 672. The vehicle 630 may update the road profile based on the other updated road profiles from the vehicles 610, 620, 640 such that subsequent drives over the road segment 670 may be based on updated or refined information about the road segment 670 and the road hazard 672.

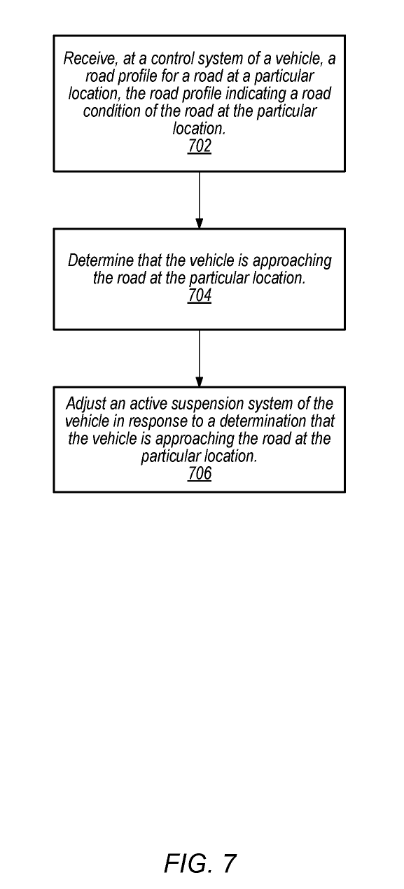

FIG. 7 illustrates a flowchart diagram of a method to minimize motion of a vehicle. The vehicle may correspond to the vehicle 100 of FIG. 1, the vehicle 210 of FIG. 2, the vehicle 310 of FIG. 3 or the vehicle 402 of FIG. 4. The method may be implemented by any of the embodiments of control systems, control units, etc., disclosed herein. A control system, control unit, etc., can be implemented by one or more computer systems. The control system may correspond to the control system 112 of FIG. 1 or the control system 404 of FIG. 4. Such motion minimization can include communicating information regarding one or more aspects of the vehicle, an external environment through which the vehicle is being navigated, one or more traffic participants located in the external environment, some combination thereof, etc.

At 702, the control system receives a road profile for a road at a particular location, the road profile indicating a road condition of the road at the particular location. For example, the road profile may indicate that a road hazard on the road at the particular location. The road profile may correspond to the road profile 314 of FIG. 3.

At 704, the control system determines that the vehicle is approaching the road at the particular location. For example, the control system may determine a current location of the vehicle and determine that the current location is relatively close to the particular location identified in the road profile. For example, the vehicle may include a location sensor configured to generate location data about the vehicle. The control system may use the location data to determine that the vehicle is approaching the particular location.

At 706, an active suspension system is adjusted in response to a determination that the vehicle is approaching the road at the particular location. For example, the control system may instruct control elements to adjust suspension actuators of the active suspension system to increase or decrease actuation of the suspension actuators. The suspension actuators may correspond to the suspension actuators 130A-B of FIG. 1. For example, the road profile may indicate an oncoming road hazard that requires a particular level of actuation for the suspension actuators such that the control system may preemptively instruct the control elements to accommodate for the road hazard.

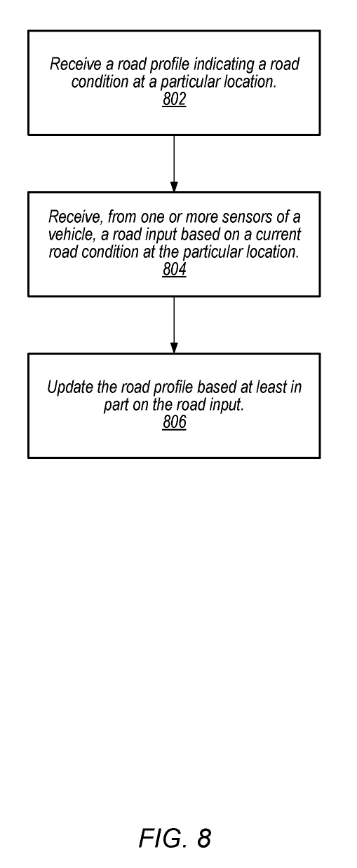

FIG. 8 illustrates a flowchart diagram of a method to update a road profile configured to minimize motion of a vehicle. The vehicle may correspond to the vehicle 100 of FIG. 1, the vehicle 210 of FIG. 2, the vehicle 310 of FIG. 3 or the vehicle 402 of FIG. 4. The method may be implemented by any of the embodiments of control systems, control units, etc., disclosed herein. A control system, control unit, etc., can be implemented by one or more computer systems.

At 802, a road profile indicating a road condition at a particular location is received. For example, road profile may indicate presence of a road hazard at the particular location that may cause the vehicle to adjust one or more control elements to accommodate for the road hazard. A particular level of adjustment may be applied to a particular suspension actuator of the control elements and may be distinct from another suspension actuator of the control elements.

At 804, a road input based on a current road condition at the particular location is received from one or more sensors of the vehicle. For example, the road input may include sensor data captured or generated by the at least one sensor that is configured to capture data about external circumstances that affect movement or motion of the vehicle. For example, the at least one sensor may be an external sensor configured to determine presence of a road hazard, such as a pothole, in a road surface at a particular location.

At 806, the road profile is updated based at least in part on the road input. For example, the vehicle may determine new information from the road input that was not present in previous trips over the particular location. For example, the new information may include whether the road hazard is no longer present (e.g., a fixed pothole) or that the road hazard requires additional adjustment of the active suspension system (e.g., a deeper pothole).

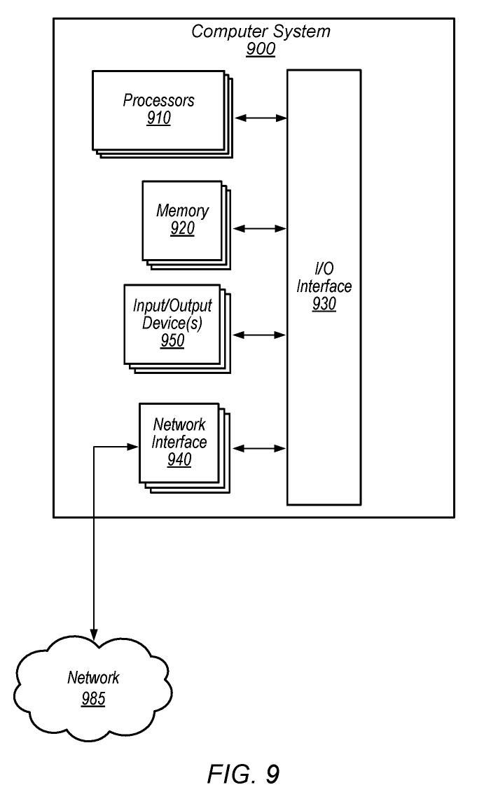

FIG. 9 illustrates an example computer system 900 that may be configured to include or execute any or all of the embodiments described above. In different embodiments, computer system 900 may be any of various types of devices, including, but not limited to, a personal computer system, desktop computer, laptop, notebook, tablet, slate, pad, or netbook computer, cell phone, smartphone, PDA, portable media device, mainframe computer system, handheld computer, workstation, network computer, a camera or video camera, a set top box, a mobile device, a consumer device, video game console, handheld video game device, application server, storage device, a television, a video recording device, a peripheral device such as a switch, modem, router, or in general any type of computing or electronic device.

Various embodiments of an audio communication system, talker feedback system, some combination thereof, etc., as described herein, may be executed in one or more computer systems 900, which may interact with various other devices. Note that any component, action, or functionality described above with respect to FIGS. 1 through 7 may be implemented on one or more computers configured as computer system 900 of FIG. 9, according to various embodiments. In the illustrated embodiment, computer system 900 includes one or more processors 910 coupled to a system memory 920 via an input/output (I/O) interface 930. Computer system 900 further includes a network interface 940 coupled to I/O interface 930, and one or more input/output devices, which can include one or more user interface (also referred to as “input interface”) devices. In some cases, it is contemplated that embodiments may be implemented using a single instance of computer system 900, while in other embodiments multiple such systems, or multiple nodes making up computer system 900, may be configured to host different portions or instances of embodiments. For example, in one embodiment some elements may be implemented via one or more nodes of computer system 900 that are distinct from those nodes implementing other elements.

In various embodiments, computer system 900 may be a uniprocessor system including one processor 910, or a multiprocessor system including several processors 910 (e.g., two, four, eight, or another suitable number). Processors 910 may be any suitable processor capable of executing instructions. For example, in various embodiments processors 910 may be general-purpose or embedded processors implementing any of a variety of instruction set architectures (ISAs), such as the x86, PowerPC, SPARC, or MIPS ISAs, or any other suitable ISA. In multiprocessor systems, each of processors 910 may commonly, but not necessarily, implement the same ISA.

System memory 920 may be configured to store program instructions, data, etc. accessible by processor 910. In various embodiments, system memory 920 may be implemented using any suitable memory technology, such as static random access memory (SRAM), synchronous dynamic RAM (SDRAM), nonvolatile/Flash-type memory, or any other type of memory. In the illustrated embodiment, program instructions included in memory 920 may be configured to implement some or all of an ANS, incorporating any of the functionality described above. Additionally, existing control data of memory 920 may include any of the information or data structures described above. In some embodiments, program instructions and/or data may be received, sent or stored upon different types of computer-accessible media or on similar media separate from system memory 920 or computer system 900. While computer system 900 is described as implementing the functionality of functional blocks of previous FIGs., any of the functionality described herein may be implemented via such a computer system.

In one embodiment, I/O interface 930 may be configured to coordinate I/O traffic between processor 910, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between computer system 900 and other devices attached to a network 985 (e.g., carrier or agent devices) or between nodes of computer system 900. Network 985 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 940 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices may, in some embodiments, include one or more display terminals, keyboards, keypads, touchpads, scanning devices, voice or optical recognition devices, or any other devices suitable for entering or accessing data by one or more computer systems 900. Multiple input/output devices may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

Memory 920 may include program instructions, which may be processor-executable to implement any element or action described above. In one embodiment, the program instructions may implement the methods described above. In other embodiments, different elements and data may be included. Note that data may include any data or information described above.

Those skilled in the art will appreciate that computer system 900 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A method, comprising:
receiving, at a control system of a vehicle, a road profile for a road at a particular location, the road profile indicating a road condition of the road at the particular location;
determining that the vehicle is approaching the road at the particular location; and
adjusting an active suspension system of the vehicle in response to a determination that the vehicle is approaching the road at the particular location.

2. The method of claim 1, wherein determining that the vehicle is approaching the road at the particular location comprises:
receiving location data from a GPS (global positioning satellite) system; and
determining a relative distance to the particular location.

3. The method of claim 1, further comprising:
receiving, from one or more sensors coupled to one or more wheels of the vehicle, wheel movement data based on the road condition of the road at the particular location; and
generating the road profile for the road at the particular location based on the wheel movement data.

4. The method of claim 1, wherein the road profile indicates that the road at the particular location includes a road hazard.

5. The method of claim 4, wherein adjusting the active suspension system comprises:
calculating a particular adjustment for one or more control elements of the active suspension system based on the road hazard; and
adjusting the one or more control elements based on the particular adjustment.

6. The method of claim 1, wherein adjusting the active suspension system comprises:
generating a suspension adjustment profile; and
storing the suspension adjustment profile to a memory of the vehicle.

7. A system, comprising:
an active suspension system coupled to a plurality of wheels of a vehicle;
one or more sensors coupled to the plurality of wheels, the one or more sensors configured to generate sensor data based on road inputs applied to the plurality of wheels;
a location sensor configured to generate location data indicating a current location of the vehicle; and
a controller configured to:
receive a road profile indicating a road condition of a road at a particular location;
update the road profile based on the sensor data; and
store the road profile to a memory of the vehicle.

8. The system of claim 7, further comprising a communication device configured to communicate with an external device.

9. The system of claim 8, wherein the external device comprises a remote server, and wherein the communication device is configured to receive the road profile from the remote server.

10. The system of claim 8, wherein the external device is included in a highway infrastructure, and wherein the communication device is configured to receive the road profile via a vehicle-to-infrastructure communication channel from the external device.

11. The system of claim 8, wherein the road profile is received from a memory of the vehicle, and wherein the communication device is further configured to receive an external road profile generated by another vehicle, wherein the controller is further configured to update the road profile based on the external road profile.

12. The system of claim 7, wherein the one or more road sensors are further configured to:
receive the road inputs based on a current road condition at the particular location; and
generate wheel movement data based on the road input,
wherein the controller is further configured to update the road profile based on the wheel movement data.

13. The system of claim 12, wherein the controller is further configured to generate a suspension adjustment profile based on the wheel movement data and the road input, wherein the active suspension system is adjusted based on the suspension adjustment profile.

14. The system of claim 7, wherein the one or more road sensors comprise a plurality of accelerometers, wherein each wheel of the vehicle is coupled to at least one accelerometer of the plurality of accelerometers.

15. The system of claim 7, further comprising:
an unsprung mass, wherein the unsprung mass comprises the plurality of wheels and the one or more sensors; and
a sprung mass, wherein the sprung mass comprises a body of the vehicle and a frame of the vehicle.

16. The system of claim 7, further comprising a visual sensor configured to estimate a current road condition at the particular location, wherein the controller is further configured to update the road profile based on the current road condition.

17. The system of claim 7, wherein the controller is further configured to:
determine a travel path for the vehicle based on the road profile indicating a road hazard at the particular location; and
sending a navigation signal to a navigation controller of the vehicle, wherein the navigation controller is configured to cause the vehicle to move along the travel path based on the navigation signal.

18. A non-transitory computer-readable storage medium storing instructions that, when executed by one or more processors, cause the one or more processors to perform operations including:
receiving a road profile indicating a road condition at a particular location;
receiving, from one or more sensors of a vehicle, a road input based on a current road condition at the particular location; and
updating the road profile based at least in part on the road input.

19. The non-transitory computer-readable storage medium of claim 19, wherein the operations further include:
sending, to an active suspension system of the vehicle, an adjustment command that is generated based on the road profile.

20. The non-transitory computer-readable storage medium of claim 19, wherein the operations further include:
sending, to an external device, the updated road profile; and
requesting, from the external device, a revised road profile, wherein the external device is configured to further refine the updated road profile based on road inputs received by other vehicles.
